(19) United States
(12) Patent Application Publication
(10) Pub. No.: US 2026/0286031 A1
(43) Pub. Date: Sep. 24, 2026

(54) Solution-Based Synthesis of Chalcogenide Polymers

(71) Applicant: The Government of the United States of America, as represented by the Secretary of the Navy, Arlington, VA (US)

(72) Inventors: Darryl A. Boyd, Washington, DC (US); Vinh Q. Nguyen, Washington, DC (US); Kenneth J. Ewing, Washington, DC (US); Daniel G. Gibson, Washington, DC (US); Robert N. Nicol, Washington, DC (US); Woohong Kim, Washington, DC (US); Jasbinder S. Sanghera, Washington, DC (US)

(73) Assignee: The Government of the United States of America, as represented by the Secretary of the Navy, Arlington, VA (US)

(21) Appl. No.: 19/572,011

(22) Filed: Mar. 19, 2026

Related U.S. Application Data
(60) Provisional application No. 63/775,659, filed on Mar. 21, 2025.

(51) Int. Cl. C08F 228/02; C08F 2/06; C08F 6/12; C08F 230/04

(52) U.S. Cl. CPC C08F 228/02; C08F 2/06; C08F 6/12; C08F 230/04; C08F 2800/10

(57) ABSTRACT

A method for synthesizing a chalcogenide polymer, the method comprising combining at least one chalcogen element, at least one organic comonomer, and a solvent in a reaction vessel to form a mixture, rendering the mixture in the reaction vessel substantially air-free, and heating the substantially air-free mixture to a temperature sufficient to cause polymerization of the at least one chalcogen element and the at least one organic comonomer, thereby forming the chalcogenide polymer within the solvent. A chalcogenide polymer prepared by a method for synthesizing a chalcogenide polymer comprising combining at least one chalcogen element, at least one organic comonomer, and a solvent in a reaction vessel to form a mixture, rendering the mixture in the reaction vessel substantially air-free, and heating the substantially air-free mixture to a temperature to cause polymerization of the chalcogen element and the organic comonomer, thereby forming the chalcogenide polymer within the solvent.

### REFERENCE TO RELATED APPLICATION

This application is a non-provisional of, and claims priority to and the benefits of, U.S. Provisional Patent Application No. 63/775,659 filed on Mar. 21, 2025, the entirety of which is herein incorporated by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; techtran@nrl.navy.mil, referencing Navy Case #212637.

### BACKGROUND

This invention disclosure relates generally to a synthetic process of making chalcogenide-based polymeric materials which transmit in the visible to the long wavelength infrared, and the conversion of those materials into optical form factors, such as windows, lenses and fibers.

In recent years, there has been a resurgence in chalcogen focused research, particularly as it pertains to sulfur-containing polymers.

Sulfur is an earth-abundant element that possesses properties that are useful in a number of scientific research fields. In the realm of polymer optics, sulfur is often added to increase the refractive index. When heated in ambient conditions to temperature (T) greater than 160° C., sulfur becomes a red-transparent, solid-like material that has unique infrared transmission capabilities.

However, once the sulfur cools to room temperature, it returns to its opaque-yellow original form. In 2013, it was reported that elemental sulfur could be arrested in a useful red-transparent polymer form by heating it in combination with divinyllic comonomers at T>160° C. Shortly thereafter, similar methods for synthesizing polymers with both sulfur and selenium incorporated into them were also reported.

Since the initial report, there have been methods reported to improve upon the synthesis of these chalcogen-rich polymers including catalytic synthesis and non-thermal ultraviolet irradiation synthesis methods. The most common method of synthesis entails heating elemental sulfur in a reaction vessel until it is molten (T>120° C.), and continuing to heat the sulfur to temperatures that are greater than the ring-opening temperature of sulfur Ss rings (160° C.<T<200° C.). Then a comonomer that typically contains two or more vinyl groups, like 1,3-diisopropenyl benzene (DIB) or divinylbenzene (DVB), is added to the reaction vessel while stirring. The formation of a polymer often occurs within 6-10 minutes, and the polymer can be removed/scraped from the reaction vessel. At this point, the polymer often undergoes a thermal post-cure step in a separate container at T>185° C.

Although this synthesis process (and variations of it) successfully produces sulfur-rich polymers, there are notable drawbacks to the method.

For example, the “open-air,” ambient nature of prior synthesis methods leaves the reaction process susceptible to oxygen-inhibition, and the resulting polymers susceptible to air contamination.

Furthermore, this method consistently produces toxic H₂S gas as a byproduct.

Herein, we demonstrate a solution to these long-standing problems with our solution-based synthesis of chalcogenide polymers, and the product thereof.

### SUMMARY OF DISCLOSURE

### Description

This invention relates generally to a synthetic process of making chalcogenide-based polymeric materials which transmit in the visible to the long wavelength infrared, and the conversion of those materials into optical form factors, such as windows, lenses and fibers.

The polymers of our invention are synthesized using a solvent-based method performed in an air-free closed system, which is a major departure from ambient techniques typically used to synthesize sulfur-rich polymers.

The use of a solvent decreases the viscosity of the molten chalcogen component(s), allowing for greater homogeneous mixing of the reagents.

The polymers synthesized in this invention are composed of chalcogen elements, such as sulfur and selenium, along with organic and/or organometallic comonomer moieties.

The properties of these polymers (e.g. optical transmission, refractive index) can be controlled by exploiting the properties of both the chalcogen and organic comonomer components.

The development of inorganic/organic hybrid polymers that can transmit light in the infrared is a critical technological advantage in comparison to common, organic polymers which tend to be non-transmissive in the infrared. Infrared transmission is required for many applications including chemical sensing and infrared detection.

The current invention, concerning our solution-based synthesis of chalcogenide polymers, and the products thereof, solves the long-standing problems of the prior art.

### DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description when considered in conjunction with the drawings.

FIG. 1 illustrates an unpolished Poly(S-r-DIB) ORMOCHALC polymer visualized via digital camera on top of the USNRL logo in front of a light bulb (left), a soldering iron heated to 180° C. and visualized from 1-5 μm with a SWIR/MWIR camera (center), and poly(S-r-DIB) ORMOCHALC polymer visualized from 1-5 μm in front of the soldering iron heated to 180° C.; polymer indicated by the dotted outline (right). Substrate thickness=1.67 mm.

FIG. 2 illustrates a UV-vis-NIR-SWIR spectrum for 2 mm thick poly(S-r-DVB).

FIG. 3 illustrates a FTIR spectrum for 2 mm thick poly(S-r-DVB).

FIG. 4 illustrates a Raman spectrum comparison of poly(S-r-DVB) with elemental sulfur.

FIG. 5 illustrates a three step (heating-cooling-reheating) differential scanning calorimetry (DSC) plot for poly(S-r-DVB) which shows a reversable glass transition (Tg) onset at −14° C. Sample was heated from −50° C. to 175° C. (10° C./min), cooled to −75° C. (−5° C./min) and then reheated to 175° C. (10° C./min).

FIG. 6 illustrates a thermo-gravimetric analysis (TGA) plot for poly(S-r-DVB) which shows a slight change in sample weight upon heating to 170° C. at a rate of 10° C./minute. The cumulative weight loss was only 0.67% at 170° C.

FIG. 7 illustrates a thermo-mechanical analysis (TMA) plot for poly(S-r-DVB). A 1.9 mm thick sample was heated at a rate of 10° C./min under 0.02N load until slumping was observed at 48° C. The coefficient of thermal expansion (CTE) was 63 μm/m/° C. or parts-per-million(ppm)/° C. below 0° and 583 ppm/° C. in the range of 25-40° C. The transition temperature between these two regimes (TG) is 18° C.

FIG. 8 is a table of refractive index values for poly(S-r-DVB).

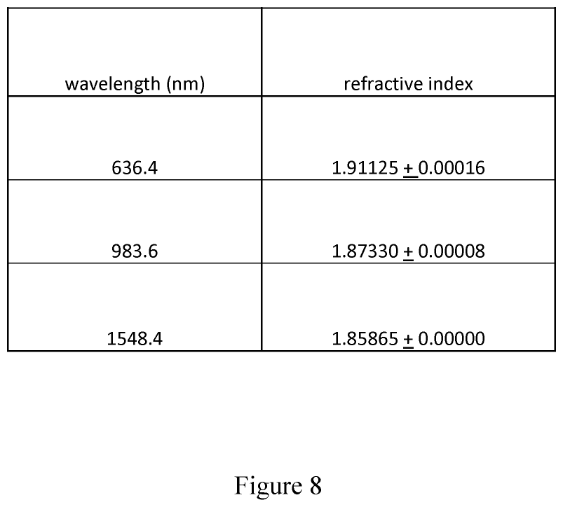

### DETAILED DESCRIPTION OF THE INVENTION

This invention relates generally to a synthetic process of making chalcogenide-based polymeric materials which transmit in the visible to the long wavelength infrared, and the conversion of those materials into optical form factors, such as windows, lenses and fibers.

The polymers of our invention are synthesized using a solvent-based method performed in an air-free closed system, which is a major departure from ambient techniques typically used to synthesize sulfur-rich polymers.

The current invention, concerning our solution-based synthesis of chalcogenide polymers, and the products thereof, solves the long-standing problems of the prior art.

The use of a solvent decreases the viscosity of the molten chalcogen component(s), allowing for greater homogeneous mixing of the reagents.

The polymers synthesized in our invention are composed of chalcogen elements, such as sulfur and selenium, along with organic and/or organometallic comonomer moieties.

The properties of these polymers (e.g. optical transmission, refractive index) can be controlled by exploiting the properties of both the chalcogen and organic comonomer components.

The development of inorganic/organic hybrid polymers that can transmit light in the infrared is a critical technological advantage in comparison to common, organic polymers which tend to be non-transmissive in the infrared. Infrared transmission is required for many applications including chemical sensing and infrared detection.

This disclosed invention details the fabrication and use of chalcogenide-based, inorganic/organic hybrid polymers that enable transmission over a broad spectral range of light from the visible into the very long-wavelength infrared (VLWIR) region of the electromagnetic spectrum (0.4-25 μm).

These polymers commonly possess high refractive indices (n>1.7) which can be tailored via compositional control (e.g. ratio of chalcogen-to-organic comonomer moiety), which makes them particularly suitable for numerous optical applications, including for sensing, signal transmission and other uses.

Finally, these chalcogen-rich polymers are far lighter and cheaper per unit volume than infrared transmissive glass materials currently on the market.

### Example 1

A method for synthesizing a chalcogenide polymer, the method comprising combining at least one chalcogen element, at least one organic comonomer, and a solvent in a reaction vessel to form a mixture, rendering the mixture in the reaction vessel substantially air-free or absent of air or no air present or without air, and heating the substantially air-free mixture to a temperature sufficient to cause polymerization of the at least one chalcogen element and the at least one organic comonomer, thereby forming the chalcogenide polymer within the solvent.

### Example 2

A chalcogenide polymer prepared by a method for synthesizing a chalcogenide polymer, the method comprising combining at least one chalcogen element, at least one organic comonomer, and a solvent in a reaction vessel to form a mixture, rendering the mixture in the reaction vessel substantially air-free or absent of air or no air present or without air, and heating the substantially air-free mixture to a temperature sufficient to cause polymerization of the at least one chalcogen element and the at least one organic comonomer, thereby forming the chalcogenide polymer within the solvent.

### Example 3

### Chalcogenide Polymer Synthesis for Optics

Example sulfur-rich polymer synthesis using the new invention is as follows. Polycrystalline sulfur is purified by a distillation process.

The solid polycrystalline sulfur (S), (70% by mass or 90 mol %) and comonomer divinylbenzene (DVB), (30% by mass or 10 mol %) are placed in a round-bottom flask (RBF) with sufficient volume of the solvent ortho-dichlorobenzene (DCB) and a magnetic stir bar.

The RBF is connected to a condenser that is connected to a Schlenk line. Once connected to the Schlenk line, the air is removed from the reagents within the RBF using appropriate air-free techniques (e.g. at least two “freeze-pump-thaw” cycles).

Once at room temperature, the solution in the RBF—while still connected to the Schlenk line and under inert gas (e.g. nitrogen, argon)—is heated with an oil bath (temperature>120° C.) to the reflux temperature of the solvent (e.g. DCB).

The reflux proceeds under inert gas for 4-18 hrs.

### Example 4

The reaction product is then extracted by one of 2 methods:
1. Remove the solvent by heating/evaporation and/or by drying under reduced pressure (i.e. vacuum).
2. Precipitate out the product by pouring the reaction mixture into a miscible non-solvent (e.g. methanol) while stirring. Then pour the mixture through a funnel covered with filter paper to leave behind the product. Finally place the remaining solid product in a vacuum-safe container and dry under vacuum (e.g. on a Schlenk line).

### Example 5

The dried product can then be placed in a mold and cured in a preheated furnace at temperatures between 100-200° C.

The molded and cured product can then be removed from the furnace to allow the polymer material to cool and be extracted in freestanding form.

Depending on the reagents and solvents used, as well as the intended product application, this curing step may not be necessary.

This fabrication methodology was also demonstrated to produce polymer materials containing different ratios and species of chalcogen elements including sulfur, selenium, and sulfur/selenium mixtures at suitable processing temperatures and times.

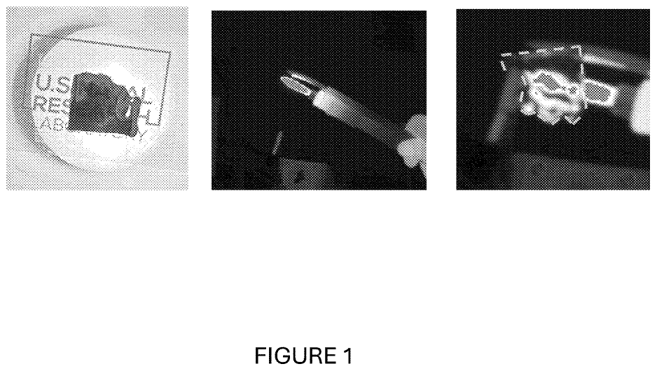

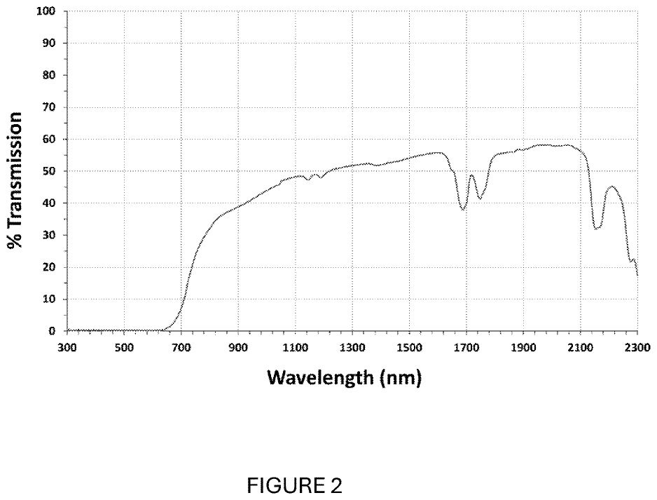

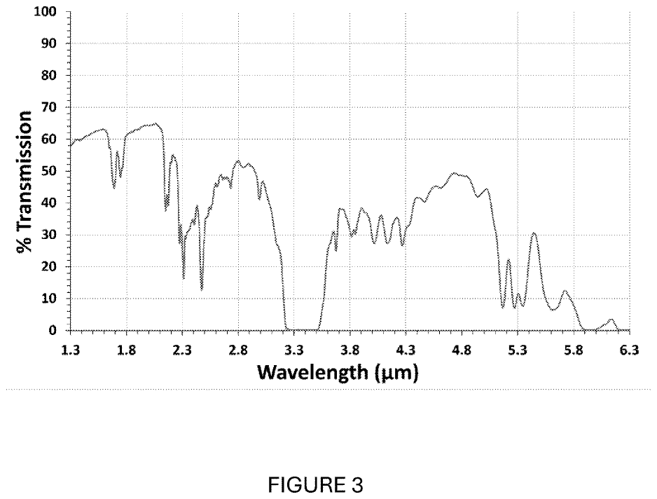

Optical transparency is demonstrated through the resulting material (FIGS. 1-3), while high refractive index values are attainable from the visible into the near infrared (Table 1).

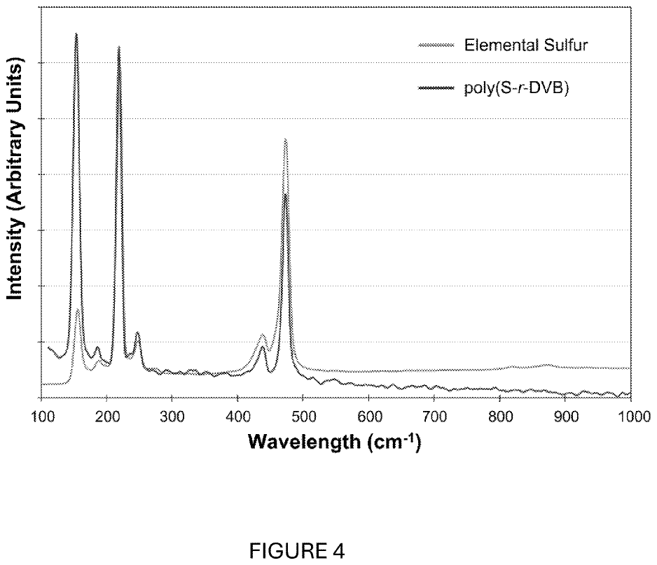

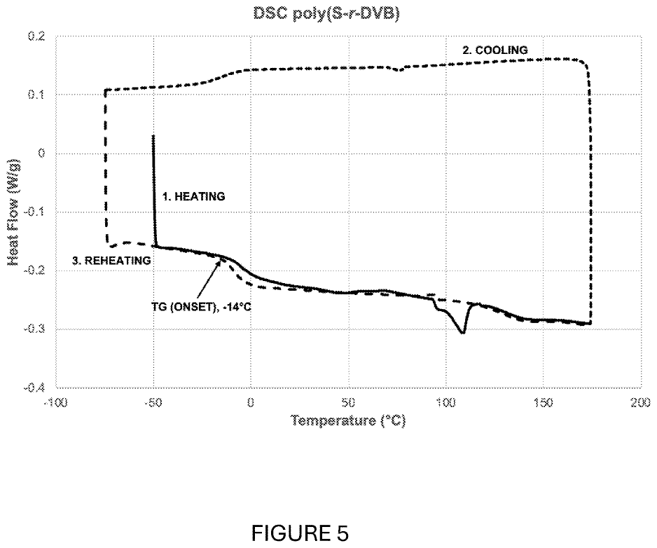

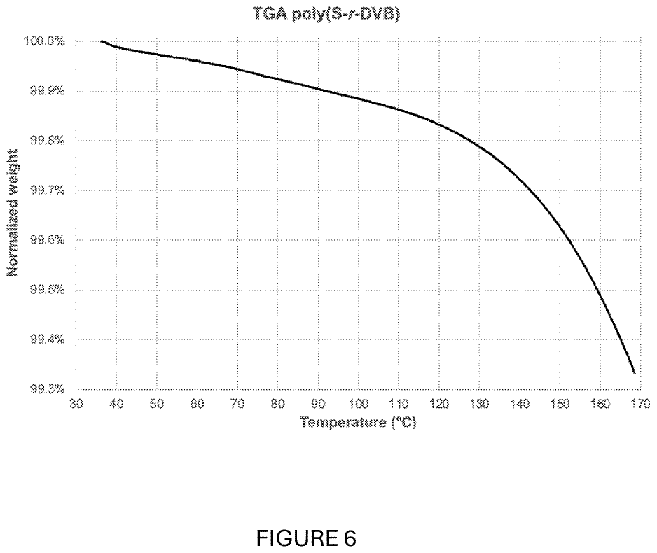

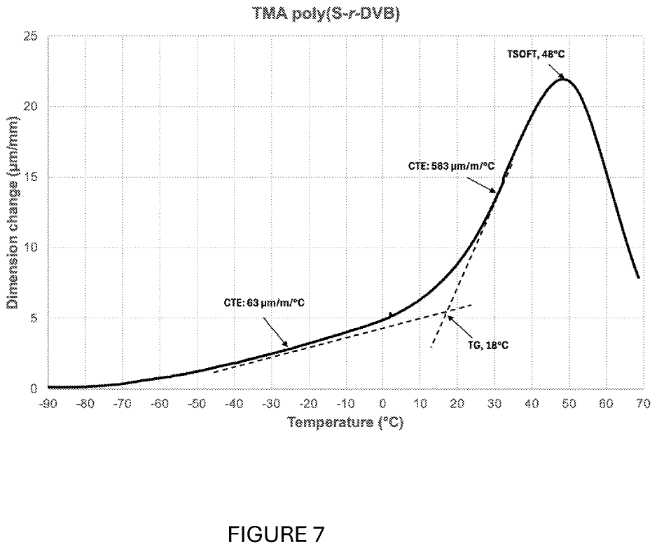

Characteristic peaks of the reagents are identifiable (FIG. 4). Thermal analysis (FIGS. 5-7) indicates thermal stability to temperatures greater than 170° C., with a softening point of 48° C., a Glass transition temperature onset of −14° C., and a Glass transition temperature midpoint of 18° C.

The example embodiment presented here is a chalcogen-based polymer, made via a solution-based synthesis method, with a ratio of 54.3 mol % S₈ to 45.7 mol % DVB.

Other embodiments using a similar method but with different ratios of Ss to DVB and/or the inclusion of other chalcogen and non-chalcogen elements will result in polymer products with different thermal and optical properties and are also claimed in this disclosure.

### Advantages and New Features

1) Our disclosure demonstrates provides a synthesis method that enables the preparation of chalcogen-rich materials within a solvent system.
2) This detailed invention provides a method for the fabrication of polymers containing chalcogen (i.e. sulfur or selenium or tellurium) comonomers with organic comonomers.
3) The disclosed invention provides a method for the fabrication of polymers containing blended chalcogen (i.e. sulfur-selenium, sulfur-tellurium, sulfur-germanium, sulfur-antimony, sulfur-selenium-tellurium, selenium-tellurium) comonomers with organic comonomers.
4) Our invention provides a method for the fabrication of infrared transmitting polymers containing low boiling point organic comonomers.
5) This disclosure provides a method for the fabrication of chalcogenide-based polymers that is not limited by reagent viscosities.
6) This invention provides a polymeric chalcogen-based material possessing infrared transmission capability that functions from the visible into the very-long wavelength (VLWIR).
7) Our detailed invention provides a method for the synthesis of a material that can be formed into multiple form-factors, including lenses, windows, fibers, etc.
8) This disclosure provides a method for the extraction and reconstitution of a polymer from a solution.
9) Other non-chalcogen elements, such as germanium, antimony or tin, can also be used in any percentage combination as a part of the chalcogen-organic comonomer materials.
10) Comonomers other than DVB can also be used in the fabrication process as comonomers.
11) Mixtures of comonomers can also be used in the fabrication process.
12) Reducing agents, such as beta-mercaptoethanol or sodium borohydride, can be included as a reagent in the reaction.
13) The addition of a base, such as potassium hydroxide, can be included as a reagent in the reaction.
14) The at least one organic comonomer comprises a molecule with two or more vinyl and/or ethynyl groups.
15) The reaction temperature can vary.
16) The reaction time can vary.
17) The product cure time can vary.
18) Non-thermal methods of curing can be employed to cure the polymer (e.g. UV irradiation, laser energy, or their combination).
19) The ratio of chalcogen to comonomer can vary.

The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

What we claim is:

1. A method for synthesizing a chalcogenide polymer, the method comprising:
a. combining at least one chalcogen element, at least one organic comonomer, and a solvent in a reaction vessel to form a mixture;
b. rendering the mixture in the reaction vessel substantially air-free; and
c. heating the substantially air-free mixture to a temperature sufficient to cause polymerization of the at least one chalcogen element and the at least one organic comonomer, thereby forming the chalcogenide polymer within the solvent.

2. The method of claim 1, wherein the at least one chalcogen element is selected from the group consisting of sulfur (S), selenium (Se), tellurium (Te), and mixtures thereof.

3. The method of claim 1, wherein the at least one organic comonomer comprises a molecule with two or more vinyl and/or ethynyl groups.

4. The method of claim 3, wherein the at least one organic comonomer is selected from the group consisting of divinylbenzene (DVB), 1,3-diisopropenyl benzene (DIB), and mixtures thereof.

5. The method of claim 1, wherein rendering the mixture substantially air-free comprises performing at least one freeze-pump-thaw cycle or purging the reaction vessel with an inert gas.

6. The method of claim 1, wherein heating the mixture comprises heating the mixture to the reflux temperature of the solvent.

7. The method of claim 1, further comprising the step of extracting the chalcogenide polymer from the solvent after polymerization.

8. The method of claim 7, wherein extracting the chalcogenide polymer is achieved by evaporating the solvent or by precipitating the polymer in a non-solvent.

9. The method of claim 7, further comprising the step of curing the extracted chalcogenide polymer in a mold.

10. The method of claim 9, wherein the curing is performed via a thermal method or a non-thermal method selected from the group consisting of ultraviolet (UV) irradiation and laser irradiation.

11. The method of claim 1, wherein the mixture further comprises at least one non-chalcogen element selected from the group consisting of germanium (Ge), antimony (Sb), and tin (Sn).

12. The method of claim 1, wherein the reaction includes at least one reducing agent is added as a reagent.

13. The method of claim 12, wherein the at least one reducing agent comprises at least one member selected from the group consisting of beta-mercaptoethanol, sodium borohydride, and mixtures thereof.

14. The method of claim 1, wherein at least one base is added as a reagent.

15. A chalcogenide polymer prepared by a method for synthesizing a chalcogenide polymer, the method comprising:
a. combining at least one chalcogen element, at least one organic comonomer, and a solvent in a reaction vessel to form a mixture;
b. rendering the mixture in the reaction vessel substantially air-free; and
c. heating the substantially air-free mixture to a temperature sufficient to cause polymerization of the at least one chalcogen element and the at least one organic comonomer, thereby forming the chalcogenide polymer within the solvent.

16. The chalcogenide polymer of claim 15, wherein the polymer is transmissive to electromagnetic radiation in a wavelength range from 0.4 μm to 25 μm.

17. The chalcogenide polymer of claim 15, wherein the polymer has a refractive index greater than 1.7 at a wavelength of 1550 nm.

18. The chalcogenide polymer of claim 15, wherein the polymer comprises approximately 90 mol % sulfur and 10 mol % divinylbenzene.

19. An optical element comprising the chalcogenide polymer of claim 15.

20. The optical element of claim 17, wherein the element is in a form factor selected from the group consisting of a lens, a window, and an optical fiber.
